(19) United States
(12) Patent Application Publication
(10) Pub. No.: US 2024/0349112 A1
(43) Pub. Date: Oct. 17, 2024

(54) AUTOMATIC USER FLOW NAVIGATION WITH PRIORITIZED USER DATA

(71) Applicant: T-MOBILE INNOVATIONS LLC, Overland Park, KS (US)

(72) Inventors: Abdul Khaliq Shaik, Overland Park, KS (US); Cheng Chang Liu, Overland Park, KS (US); Jason Bart Marshall, Olathe, KS (US); WeiQun Yan, Overland Park, KS (US); Hongkun Jin, Overland Park, KS (US)

(21) Appl. No.: 18/298,575

(22) Filed: Apr. 11, 2023

(51) Int. Cl. H04W 28/02; H04W 8/20; H04W 72/566

(52) U.S. Cl. CPC H04W 28/0268; H04W 8/20; H04W 72/566

(57) ABSTRACT

Technology is disclosed herein for operating an application service of a wireless network. In an implementation, the application service receives a request for a user experience flow from a client application of the wireless network that is executing on a user device. The application service receives data associated with the user device with respect to the wireless network. Elements of the data relate to device data and subscription data. The application service processes the data according to an ordered set of conditions until a satisfied condition is identified and determines a user experience flow according to the satisfied condition. The user experience flow includes webpage content associated with the satisfied condition. The application service sends the user experience to the client application.

### TECHNICAL FIELD

Aspects of the disclosure are related to software applications for wireless network services.

### BACKGROUND

Wireless network service providers facilitate customer interaction by providing applications by which a customer can access information and services of the service provider, whether as subscriber or as a prospective subscriber. These applications, whether web-based or natively installed on a device, provide a number of useful features by which a subscriber can manage his or her plan (e.g., pay a bill, upgrade a service, or monitor usage) and by which a prospective subscriber can learn about subscription plans or even initiate a switch to that carrier.

Application interfaces are designed to anticipate a number of different types of users and the information or service that those users are looking for. However, navigating application interfaces displayed on mobile devices such as smartphones can be complicated by limited screen real estate display at any one time (as compared to, say, a laptop computer or desktop monitor). From the users' perspective, finding the desired information or service may lead to navigating a number of screens and clicking through a number of links to find the desired information or service. For example, a customer of the wireless service may want to quickly access billing information or a payment page, while a prospective customer may be more interested in price-shopping and comparing wireless services. However, when a user engages in a lengthy, multi-step navigation process before ultimately reached the desired information or service, this degrades the customer experience, and the service provider runs the risk of losing customer engagement.

### TECHNICAL OVERVIEW

Technology is disclosed herein for operating an application service of a wireless network. In an implementation, the application service receives a request for a user experience flow from a client application of the wireless network that is executing on a user device. The application service receives data associated with the user device with respect to the wireless network. Elements of the data relate to device data and subscription data. The application service processes the data according to an ordered set of conditions until a satisfied condition is identified and determines a user experience flow according to the satisfied condition. The user experience flow includes webpage content associated with the satisfied condition. The application service sends the user experience to the client application.

In an implementation, the request for a user experience occurs in response to the client application being launched on the user device. In an implementation, the application service receives data from the user device and from the wireless network. In some implementations, the subscription data includes a plan type, a carrier type, and a contract type. In some implementations the device data includes a device type and an access type. In some implementations, to process the data, the application service successively checks each condition of the ordered set of conditions against the elements of the data until a condition is satisfied.

This Technical Overview is provided to introduce a selection of concepts in a simplified form that are further described below in the Detailed Description. It may be understood that this Technical Overview is not intended to identify key features or essential features of the claimed subject matter, nor is it intended to be used to limit the scope of the claimed subject matter.

### BRIEF DESCRIPTION OF THE DRAWINGS

FIG. 1 illustrates an operational environment for automatic user flow navigation in an implementation.

FIG. 2 illustrates a method for automatic user flow navigation in an implementation.

FIG. 3 illustrates an operational architecture for automatic user flow navigation in an implementation.

FIG. 4 illustrates an operational scenario for automatic user flow navigation in an implementation.

FIG. 5 illustrates an operational scenario for automatic user flow navigation in an implementation.

FIG. 6 illustrates a network data center architecture of wireless network in an implementation.

FIG. 7 illustrates a computing system suitable for implementing the various operational environments, architectures, processes, scenarios, and sequences discussed below with respect to the other Figures.

### DETAILED DESCRIPTION

Systems, methods, and devices are disclosed herein for technology by which an application service of a wireless network service presents targeted content in a user interface of a user computing device based on user data associated with the wireless network service. In an implementation, a client application of the wireless network service requests a user experience flow from an application service of the wireless network. The application service receives user data including device data and subscription data from the user device and from the wireless network service. The application service processes the user data to determine a user experience flow to display in the client application.

In various implementations, the user data includes information relating to a user device subscription to the wireless network such as a plan type or contract type. Plan type can include scenarios where the user device is not subscribed to the network (e.g., a prospective customer) and a carrier type indicating the carrier to which the device is subscribed. Device data can include a device type (e.g., iPhone® 13 or Samsung Galaxy®) and an access type, such as a 5G connection or connection via a Wifi gateway. Device data can also include elements relating to user activity such data consumption or errors or exceptions thrown by the network during access by the user device.

In an implementation, to process the user data, the application service checks a list of criteria or conditions against the elements or fields user data until a condition is met. When a condition is met, the application service identifies a user experience flow associated with the condition and sends it to the user device for display. For example, if the user data includes a business plan type and if the first condition satisfied is a business plan condition, the application service will identify and send a business proposition flow to the user device based on the satisfied condition.

In various implementations, the user experience flows are correlated to each of the conditions against which the user data elements are checked. User experience flows include webpage content associated with the corresponding condition, e.g., a new customer condition is associated with an introduction flow. User experience flows include multiple screens or cards formatted for display on the user device. For example, a flow may include multiple cards configured for scrolling or swiping by the user on a smartphone display.

In various implementations, processing user data and identifying a user experience flow occurs when a client application of the application service is launched on the user device. In some scenarios, processing user data and identifying a user experience are performed in a browser-based context, such as when a web-based application of the wireless network service is opened in a web browser executing on the user computing device.

In some implementations, an application service executing on the user device receives user data from the device and from the wireless network service, then processes the user data according to the ordered set of conditions until a condition is satisfied. Having identified a satisfied condition, the application service obtains the associated user experience flow from device storage or downloads the user experience flow from the wireless network service, and the client or web-based application displays the flow in the user interface. In another sense, checking the elements of the user data against a prioritized list of conditions effects a prioritization of the user data elements in that the priority of the element(s) satisfying a condition will be equivalent to the priority of that condition.

Technical effects of the technology disclosed herein include the ability to present targeted content to a user without the need to query the user to determine the user's intent or interest. For example, an existing customer may receive in his/her user experience flow a card for logging in to the user's account or for accessing billing information, information which would not be of use or interest to a prospective customer serviced by a competing service provider. Similarly, for the prospective customer, a switching flow may include a card comparing the quality of service between the network service and the competing service and a card inviting the user to sign up for trial access to the network. Thus, the user is presented with the most relevant information which reduces how much navigation the user must perform to get to that information and improves customer engagement by simplifying the interaction between the user and the application.

Moreover, the order of the conditions which the user data elements are checked against can be modified as business or marketing strategies change, reflecting a reprioritization of strategies. For example, during a marketing campaign for device upgrades, a device contract condition may be assigned a higher priority than, say, a business plan condition.

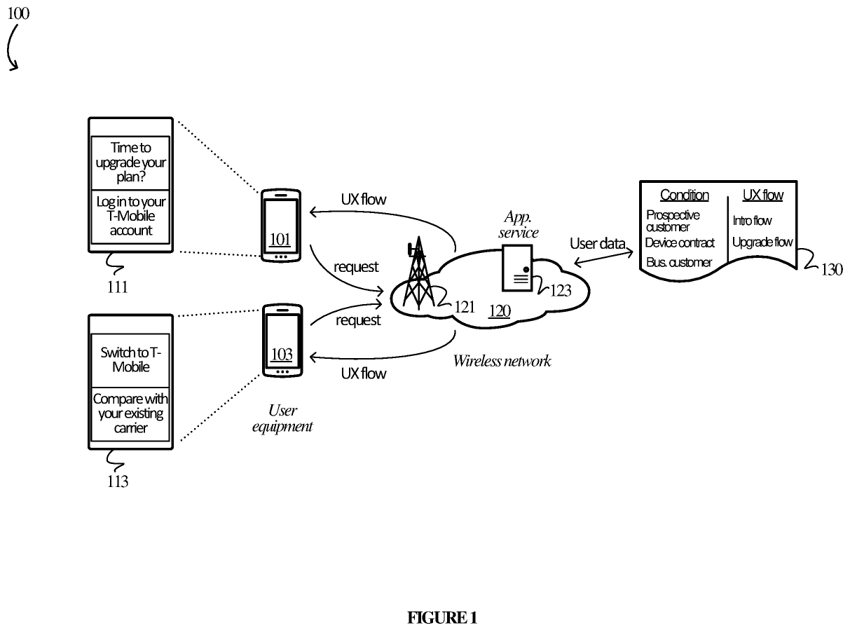

Turning now to the Figures, FIG. 1 illustrates operational scenario 100 for processing user data to identify targeted content for a user device in an implementation. Operational scenario 100 includes wireless network service 120 in communication with user devices 101 and 103 via radio access node (RAN) 121. In operation, two users operate user devices 101 and 103, respectively and independently. Wireless network service 120 also includes application service 123 and user experience (UX) flow datastore 130.

User devices 101 and 103 are representative of user equipment such as smartphones or other mobile computing devices, or laptop or desktop computers with processing circuitry for wireless communication, such as 5G-enabled smartphones and other computing devices. User devices 101 and 103 are capable of communicating with RAN 121 over radio frequency bands.

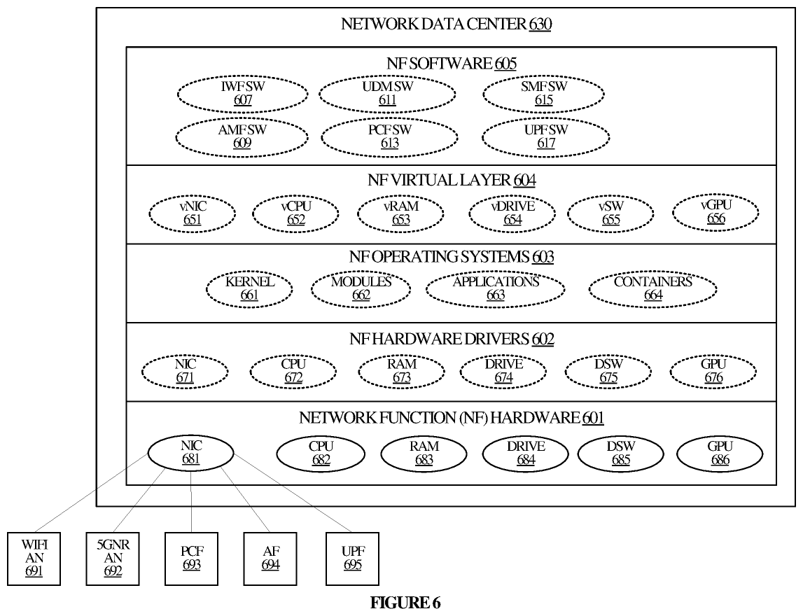

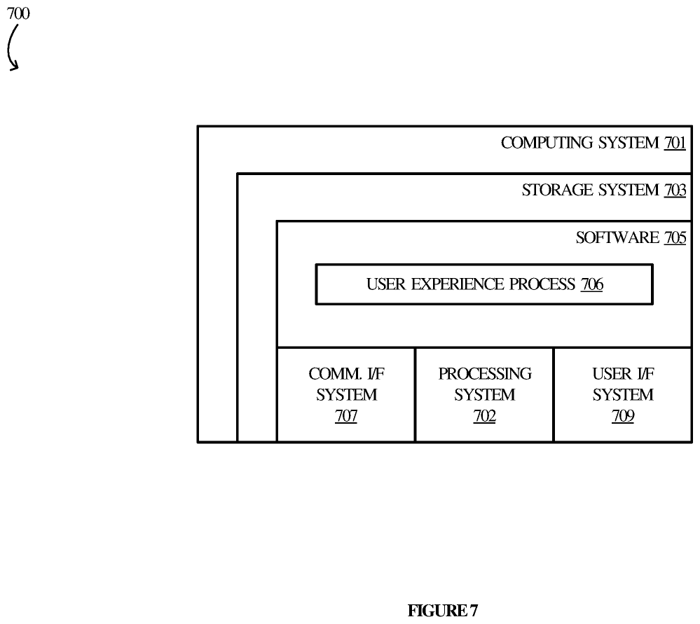

Wireless network service 120 is representative of is representative of a wireless network, such as a wireless communication network capable of using a Fifth Generation New Radio (5GNR) protocol to communicate with user devices 101 and 103 via RAN 121. The elements of wireless network service 120 are implemented on one or more suitable computing devices, of which computing device 701 of FIG. 7 is representative. Examples of suitable computing devices include server computers, blade servers, and the like. The elements of wireless network service 120 may be implemented in the context of one or more data centers, of which network data center 630 of FIG. 6 is representative, in a co-located or distributed manner, or in some other arrangement.

In operation, a client application executing on user device 101 connects with application service 123 of wireless network service 120. When the client application connects with application service 123, application service 123 receives user data relating to the device and the device subscription from user device 101. Application service 123 may also receive user data such as subscription or plan data from wireless network service 120. Application service 123 compares the user data associated with user device 101 to an ordered set of conditions to determine a user experience flow to display in the user interface of the client application. For example, if user device 101 is subscribed to wireless network service 120, user data received by application service 123 may include an access type (e.g., 5G-enabled access), subscription data indicating that the plan type is a family plan, and user activity indicating that the user is consuming his/her monthly data allocation at a particular rate. Application service 123 processes the user data by checking the ordered set of conditions against the user data until a condition is satisfied, i.e., until the one or more predicates of the condition are satisfied by the values associated with user data parameters. Continuing the brief example, a condition for plan data usage may be satisfied if the user data indicates that the user's data consumption rate is substantially higher than average, e.g., 50% higher than would be expected for the number of days into the billing cycle, or that the data allocation will be exhausted before the end of the billing cycle should the rate of consumption continue.

When application service 123 determines that a condition has been met, application service 123 identifies the user experience flow associated with the condition from UX flow datastore 130. Continuing the preceding example, in UX flow datastore 130, a plan upgrade flow may be associated with the high rate of data consumption condition. Application service 123 retrieves the plan upgrade flow from UX flow datastore 130 and sends it to the client application executing on user device 101. The client application displays the plan upgrade flow in its user interface illustrated in view 111. In view 111, the plan upgrade flow includes one or more cards associated with the associated condition, such as card prompting the user to upgrade his/her plan, a card by which the user can log into his/her account to view information about data consumption, and so on.

In some implementations, the user data from user device 101 may fail to satisfy any of the conditions, in which case application service 123 may resort to a default condition with a default user experience flow, such as an associated general purpose user experience flow. Similarly, if the user data has no elements, application service 123 may resort to the default condition and default user flow. In other scenarios, when application service 123 aggregates the user data, an element of the user data may have a null value, e.g., when the element is not applicable to the user device or does not exist. For example, if user device 103 is not subscribed to wireless network service 120, its user data element for plan type may have a null value. When checking the user data against a condition relating to plan type, the null value may satisfy a condition relating to prospective users. Similarly, for a user subscribed to a pay-as-you-go type of service, a data element relating to contract type may be null.

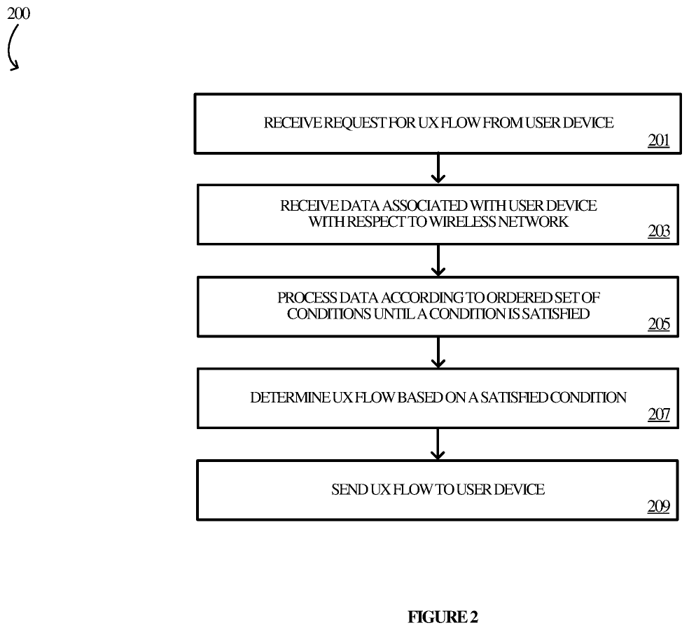

FIG. 2 illustrates process 200 for processing user data to identify targeted content for a user device in an implementation. Process 200 may be implemented on one or more computing devices, such as server computers or computers in the context of a network data center, according to program instructions which direct the computing devices to function as follows, referring parenthetically to the steps in FIG. 2 and in the singular for the sake of clarity.

An application service of a wireless communication network service receives from a client application executing on a user device a request for a user experience flow for display on the user device (step 201). The user device may be a mobile device such as a smartphone or tablet computer connecting with the service via a cellular connection (e.g., 5G) or via a Wifi connection (e.g., via Wifi gateway or router). In an implementation, the request may be sent when the application is launched on the device, while in other implementations, the client application is browser-based and the request is sent when the application is loaded into a web browser executing on the device. The user experience flow includes content formatted for display on the user device and relating to some aspect of the user device and/or the subscription status of the device with respect to the wireless network service.

At the time the request is received from the client application, the application service receives data relating to the user device associated with the wireless network service (step 203). The data received by the application service can include various types of device data, plan data, contract data, usage data, user activity data, and so on. The data may be received from the user device via the client application, or the data may be obtained from services of the wireless network service. The data received from the user device and/or the client application may be transmitted to the application service via an application programming interface (API) of the application service and in the form of a data object, such as a JSON object including data elements or fields in the form of name/value pairs.

The application service processes the data according to an ordered set of conditions (step 205). To process user data, in an implementation, the application service successively checks each condition of the ordered set of conditions against the elements or fields the user data until a condition is satisfied. The ordered set of conditions may be arranged in an order or hierarchy according to various business or marketing strategies. For example, in a highly simplified scenario, presenting a device upgrade promotion may be a higher priority than presenting a login screen or access to billing information. Thus, the condition for identifying a customer who is eligible for a device upgrade may be higher in the order than the condition for identifying a current subscription nearing the end of its monthly billing cycle, that is to say, the device upgrade condition is checked against the user data before the condition for a monthly billing date. Continuing the scenario, as the conditions are checked against the elements of the user data, when the higher priority condition is satisfied, then the application service determines a user experience flow based on the satisfied condition (step 207) and sends the user experience flow to the user device (step 209).

When the application service identifies a user experience flow based on a satisfied condition, in an implementation, it transmits the user experience flow to the user device for display in the user interface of the client application. In some scenarios, the user experience flows are stored on the user device, and the application service identifies which of the user flows to display.

Returning to FIG. 1, in operation, a client application executing on user device 103 requests a user experience flow from application service 123 of wireless network service 120. The application service 123 collects user data from user device 103 and wireless network service 120, including device data and subscription data. The user data may include data elements of fields collected by application service 123 when the client application is launched on user device 103 and stored in a dataset or data file for processing. Although an implementation of application service 123 is shown in FIG. 1 as a service of wireless network service 120, it may be appreciated that application service 123 may execute onboard user device 103 as a service of the client application or as a remotely implemented service of wireless network service 120.

Application service 123 processes the user data received from user device 103 and wireless network service 120 according to an ordered set of conditions until a condition is satisfied. In an implementation, application service 123 loops through the ordered set of conditions, checking each condition against the data fields or elements of the user data until application service 123 determines that a condition has been satisfied. To determine that condition has been satisfied, the conditions may be configured as a predicate which produces a Boolean result when applied to the corresponding data field(s). The application service 123 applies each predicate in succession to the elements of the user data, and upon a predicate returning a value of “True,” the application service 123 exits the check loop having identified a satisfied condition.

With a satisfied condition identified, application service 123 identifies a user experience flow associated with the satisfied condition. For example, if the satisfied condition relates to subscription plan for a new customer, the user experience flow may be an introduction flow comprising content which would be relevant to a user who is new to wireless network service 120. Application service 123 may retrieve the user experience flow from UX datastore 130. In various implementations, UX datastore 130 may be onboard user device 103 or it may be a service of wireless network service 120.

Upon identifying the user experience flow for the identified condition, application service 123 sends the user experience flow to the client application for display on user device 103, as illustrated in view 113 for an exemplary scenario of a prospective customer accessing wireless network service 120 via the client application.

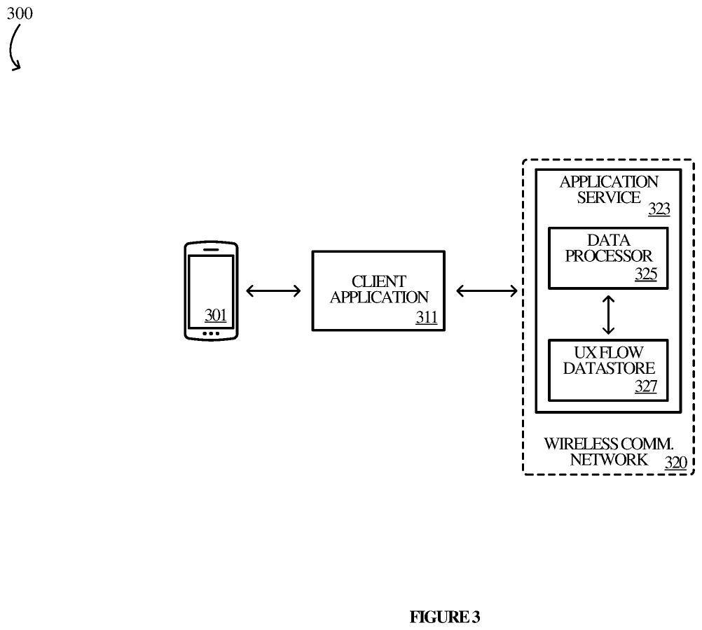

FIG. 3 illustrates operational architecture 300 for automatic user flow navigation based on prioritized user data. In an implementation, operational architecture includes user equipment 301. Client application 311 executing on user equipment 301 is in communication with application service 323 of wireless communication network 320. Application service 323 includes data processor 325 and UX flow datastore 327. In various implementations, one or more of application service 323, data processor 325, and UX flow datastore 327 may execute onboard user equipment 301 or may be hosted on wireless communication network 320 in communication with user equipment 301.

Client application 311 is representative of a natively installed and executed application, a browser-based application, or a mobile application, and may execute in a stand-alone manner, within the context of another application executing on user equipment 301 and in communication with application service 323. Client application 311 is representative of software applications capable of interfacing with wireless communication network 320 and displaying user experience flows associated with wireless communication network 320.

Application service 323 is representative of wireless communication network 320 in communication with user equipment 301 and is further representative of a service capable of employing process 200, illustrated in FIG. 2, for automatic user navigation based on prioritized user data. Data processor 325 is a subservice of application service 323 and is representative of services or subservices capable of performing user data processing as described by the technology disclosed herein. UX flow datastore 327 is a subservice of application service 323 and is representative of services or subservices which store user experience flow content in association with conditions or predicates by which the user data is prioritized.

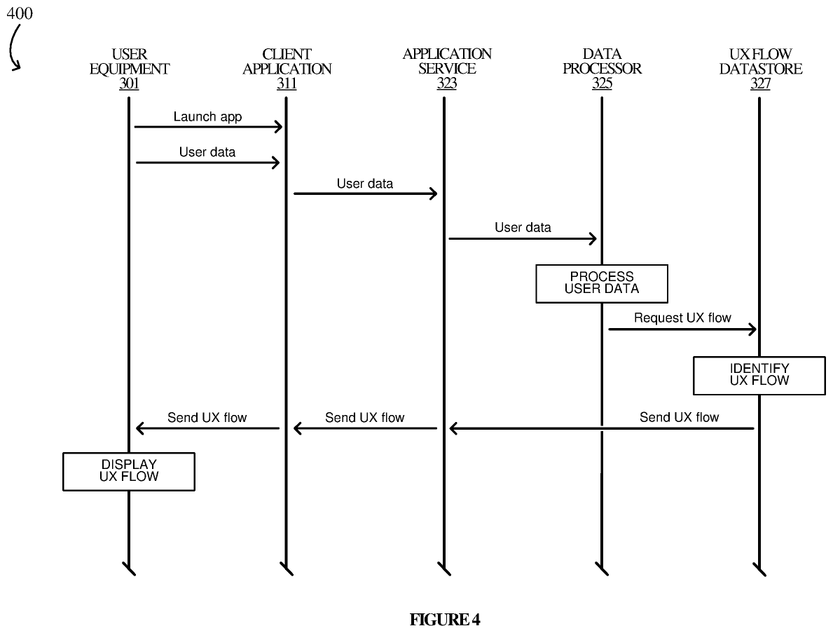

FIG. 4 illustrates operational scenario 400 with respect to the elements of FIG. 3.

In operational scenario 400, when client application 311 is launched on user equipment 301, client application 311 sends a request to application service 323 for a user experience flow for display on user equipment 301. In an implementation, application service 323 receives user data associated with user equipment 301 via client application 311, such as device data, user behavior data, plan data, access data, and so on. Application service 323 may also receive user data from wireless communication network 320, such as contract data, plan data, subscription data, billing data, network usage data, and so on.

Application service 323 submits the user data to data processing module 325 for processing. Data processor 325 processes the user data by checking a list of conditions against the user data to identify a condition satisfied by the user data. The list of conditions is ordered according to priority, with the conditions checked from highest priority to lowest. Application service 323 successively evaluates each condition against the user data until a condition is satisfied. When data processor 325 identifies a condition satisfied by one or more elements of the user data, data processor 325 sends a request for a user experience flow based on the satisfied condition to UX flow datastore 327. UX flow datastore 327 identifies the user experience flow associated with the satisfied condition and sends the flow to application service 323. Application service 323 in turn sends the flow to client application 311 which displays the flow in a user interface on user equipment 301.

In some implementations, when data processor 325 receives the user data from application service 323, data processor 325 counts the number of elements in the user data. If data processor 325 determines that the user data contains a single element of user data, data processor 325 identifies the associated user experience flow (if any) directly.

In some implementations, if the user data fails to satisfy any of the conditions for determining a user experience flow, data processor 325 returns a default user experience flow to application service 323, such as a general purpose flow.

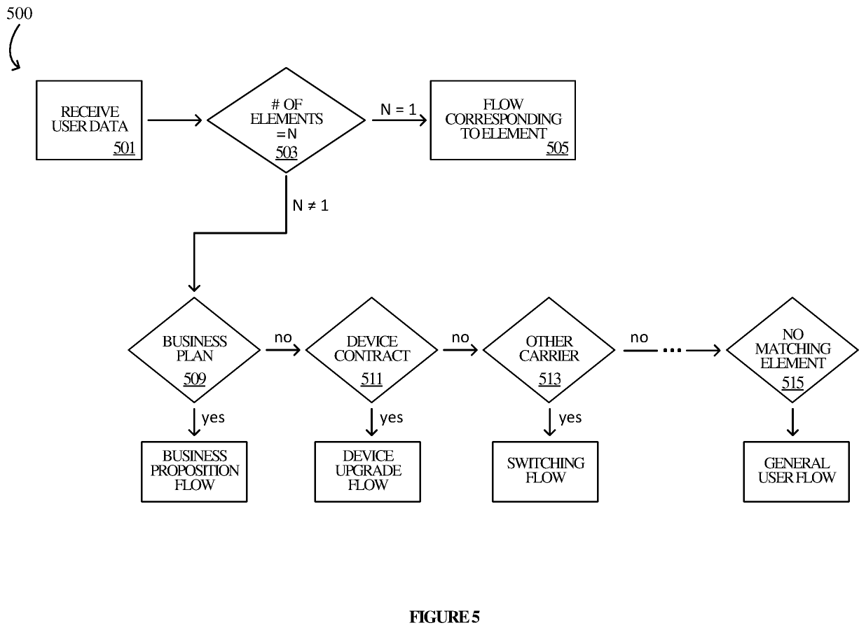

FIG. 5 illustrates process 500 for processing user data elements to determine a user experience flow in an implementation. Process 500 may be performed onboard a user device, such as user device 101 of FIG. 1, or by a wireless network service, such as wireless network service 120 of FIG. 1.

In process 500, an application service of a wireless network receives user data associated with a user device (step 501). The application service determines the number of elements or fields in the user data (step 503). If the user data has one element, the application service determines the associated user experience flow based on the element and returns the user experience flow to the client application on the user device (step 505). If the user data includes multiple elements (or zero elements), the application service processes the elements to determine a user experience flow to display on the user device.

To process the elements of the user data, the application service assesses each condition of a set of conditions against the elements of the user data to determine if elements of the user data satisfy the condition. The order in which the conditions are assessed may be prioritized according to business and/or marketing strategies. Process 500 illustrates an exemplary order of conditions for which the highest priority condition may be a business plan condition (step 509), followed by a device contract condition (step 511), followed by an other carrier condition (the user is subscribed to another wireless service provider) (step 513), and so on, until the final or default condition (step 515) which applies when none of the other conditions are satisfied or when the user data has zero elements. When a condition is satisfied (i.e., the output is “yes”), the corresponding flow is implemented.

In an implementation, the conditions which are checked against the user data may include, with their respective user experience flows (listed here in no particular order): a new customer condition with an introduction flow; a shopping status condition with a shopping flow; an issue, error, or exception condition with a help flow; a network trial user condition with a network pass flow; a carrier name condition with a switching flow; a business customer condition with a business plan flow; a device contract condition with a device upgrade flow; a Wifi gateway condition with a home Internet setup flow; a data usage condition with a plan upgrade flow; and so on.

FIG. 6 illustrates exemplary network data center 630, a network core of a wireless communication system, of which wireless network service 120 of FIG. 1 is representative. Network data center 630 includes network function (NF) software 605, network function virtual layer 604, network function operating systems 603, network function hardware drivers 602, and network function hardware 601.

Network function software 605 of network data center 630 includes software for executing various network functions: IWF software 607, AMF software 609, UDM software 611, PCF software 613, SMF software 615, and UPF software 617. Other network function software, such as network repository function (NRF) software, are typically present but are omitted for clarity.

Network function virtual layer 604 includes virtualized components of network data center 630, such as virtual NIC 651, virtual CPU 652, virtual RAM 653, virtual drive 654, virtual software 655, and virtual GPU 656. Network operating systems 603 includes components for operating network data center 630, including kernels 661, modules 662, applications 663, and containers 664 for network function software execution. Applications 663 may include applications and services relating to automated user flow navigation relating to the technology disclosed herein. Network function hardware drivers 602 include software for operating network function hardware 601 of network data center 630, including network interface card (NIC) drivers 671 for network interface cards (NICs) 681, CPU drivers 672 for CPUs 682, RAM drivers 673 for RAM 683, flash/disk drive drivers 674 for flash/disk drives 684, data switch (DSW) drivers 675 for data switches 685, and drivers 676 for GPUs 686. Of network function hardware 601 of network data center 630, network interface cards 681 include hardware components for communicating with Wifi access node 691, 5GNR access node 692, PCF 693, application server 694, and UPF 695.

Turning now to FIG. 7, architecture 700 illustrates computing device 701 that is representative of any system or collection of systems in which the various processes, programs, services, and scenarios disclosed herein may be implemented. Examples of computing device 701 include, but are not limited to, server computers, web servers, cloud computing platforms, and data center equipment, as well as any other type of physical or virtual server machine, container, and any variation or combination thereof. Examples also include desktop and laptop computers, tablet computers, mobile computers, and wearable devices.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709 (optional). Processing system 702 is operatively coupled with storage system 703, communication interface system 707, and user interface system 709. Computing device 701 may also include dedicated storage for encryption keys and the like, such as a secure keystore.

Processing system 702 loads and executes software 705 from storage system 703. Software 705 includes and implements user experience process 706, which is representative of the user experience processes discussed with respect to the preceding Figures, such as process 200 and process 500. When executed by processing system 702, software 705 directs processing system 702 to operate as described herein for at least the various processes, operational scenarios, and sequences discussed in the foregoing implementations. Computing device 701 may optionally include additional devices, features, or function not discussed for purposes of brevity.

Referring still to FIG. 9, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including user experience process 706) may be implemented in program instructions and among other functions may, when executed by processing system 702, direct processing system 702 to operate as described with respect to the various operational scenarios, sequences, and processes illustrated herein. For example, software 705 may include program instructions for implementing the user experience processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to support user experience processes. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary, etc.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The wireless data network circuitry described above comprises computer hardware and software that form special-purpose wireless system circuitry to serve wireless user devices based on policies. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose wireless system circuitry to serve wireless user devices based on policies.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents. The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for,” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

What is claimed is:

1. A method of operating an application service of a wireless network, comprising:
receiving a request for a user experience flow from a client application of the wireless network executing on a user device;
receiving user data associated with the user device with respect to the wireless network, wherein the user data comprises elements relating to device data and subscription data;
processing the user data according to an ordered set of conditions until a satisfied condition is identified, wherein the satisfied condition comprises a condition satisfied by the user data;
determining the user experience flow according to the satisfied condition, wherein the user experience flow comprises webpage content associated with the satisfied condition; and
sending the user experience flow to the client application for display on the user device.

2. The method of claim 1, wherein receiving the user data associated with the user device comprises receiving the user data associated with the user device from the user device and from the wireless network.

3. The method of claim 2, wherein processing the user data according to the ordered set of conditions until the satisfied condition is identified comprises checking each condition of the ordered set of conditions in succession against the elements of the user data until a condition is satisfied by one or more elements of the elements of the user data.

4. The method of claim 3, wherein each condition of the ordered set of conditions comprises a predicate which evaluates to True or False based on the one or more elements of the elements of the user data.

5. The method of claim 4, wherein the subscription data includes a plan type, a carrier type, and a contract type.

6. The method of claim 4, wherein the device data includes a device type and an access type.

7. The method of claim 1, wherein receiving the request for the user experience flow occurs in response to the client application being launched on the user device.

8. The method of claim 1, wherein the application service executes on the user device.

9. A computing apparatus comprising:
one or more computer-readable storage media;
one or more processors operatively coupled with the one or more computer-readable storage media; and
program instructions stored on the one or more computer-readable storage media that, when executed by the one or more processors, direct the computing apparatus to:
send, to an application service of a wireless network, a request for a user experience flow from a client application of the wireless network executing on the computing apparatus;
send, to the application service, user data associated with the computing apparatus with respect to the wireless network, wherein the user data comprises elements relating to device data and subscription data;
receive, from the application service, the user experience flow, wherein the user experience flow is determined by the application service based on the user data; and
display the user experience flow in a user interface of the client application.

10. The computing apparatus of claim 9, wherein the application service:
processes the user data according to an ordered set of conditions until a satisfied condition is identified, wherein the satisfied condition comprises a condition of the ordered set of conditions satisfied by the user data; and
determines the user experience flow according to the satisfied condition, wherein the user experience flow comprises webpage content associated with the satisfied condition.

11. The computing apparatus of claim 10, wherein to process the user data according to the ordered set of conditions, the application service checks each condition of the ordered set of conditions against the elements of the user data in succession until a condition is satisfied by one or more elements of the elements of the user data.

12. The computing apparatus of claim 11, wherein each condition of the ordered set of conditions comprises a predicate which evaluates to True or False based on the one or more elements of the elements of the user data.

13. The computing apparatus of claim 12, wherein the subscription data includes a plan type, a carrier type, and a contract type.

14. The computing apparatus of claim 12, wherein the device data includes a device type and an access type.

15. The computing apparatus of claim 9, wherein to send the request for the user experience flow, the program instructions direct the computing apparatus to send the request for the user experience flow in response to the client application being launched on the computing apparatus.

16. One or more computer-readable storage media having program instructions stored thereon that, when executed by one or more processors operatively coupled with the one or more computer-readable storage media, direct a computing device to:
send, to an application service of a wireless network, a request for a user experience flow from a client application of the wireless network executing on the computing device;
send, to the application service, user data associated with the computing device with respect to the wireless network, wherein the user data comprises elements relating to device data and subscription data;
receive, from the application service, the user experience flow, wherein the user experience flow is determined by the application service based on the user data; and
display the user experience flow in a user interface of the client application.

17. The one or more computer-readable storage media of claim 16, wherein the application service:
processes the user data according to an ordered set of conditions until a satisfied condition is identified, wherein the satisfied condition comprises a condition of the ordered set of conditions satisfied by the user data; and
determines the user experience flow according to the satisfied condition, wherein the user experience flow comprises webpage content associated with the satisfied condition.

18. The one or more computer-readable storage media of claim 17, wherein to process the user data according to the ordered set of conditions, the application service checks each condition of the ordered set of conditions in succession against the elements of the user data until a condition is satisfied by one or more elements of the elements of the user data.

19. The one or more computer-readable storage media of claim 18, wherein each condition of the ordered set of conditions comprises a predicate which evaluates to True or False based on the one or more elements of the elements of the user data.

20. The one or more computer-readable storage media of claim 15, wherein to send the request for the user experience flow, the program instructions direct the computing device to send the request for the user experience flow in response to the client application being launched on the computing device.
